(19) United States
(12) Patent Application Publication
(10) Pub. No.: US 2009/0113323 A1
(43) Pub. Date: Apr. 30, 2009

(54) DATA CENTER OPERATION OPTIMIZATION

(75) Inventors: Feng Zhao, Issaquah, WA (US); Jie Liu, Sammamish, WA (US); Michael E. Sosebee, Redmond, WA (US); Borje F.F. Karlsson, Rio de Janeiro (BZ)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/932,137

(22) Filed: Oct. 31, 2007

(51) Int. Cl. G06F 3/048

(52) U.S. Cl. 715/764

(57) ABSTRACT

Data center data associated with multiple systems and/or sources is integrated into a single system to aid efficient operation of a data center. Acquired raw data can be housed in a database, analyzed, and optimized. A user interface can render raw and/or generated data in intuitive manners (e.g., spatially, temporally . . . ) to facilitate interaction with a data center and/or components thereof. In particular, the interface can be employed to monitor and control operations as well as facilitate deployment and capacity planning, among other things.

### BACKGROUND

Data centers are facilities that host a large amount of computing and network equipment. Network accessible data is housed in centralized repositories to enhance data availability, security, and reliability while also providing high scalability and affordability due to economies of scale. For instance, data for enterprise resource processing (ERP) and customer relationship management (CRM) is typically centrally located. Data centers also facilitate distributed processing (e.g., client/server). Applications and/or services can be hosted by a data center such as databases, file servers, application servers, and middleware. By way of example, e-commerce, search, and email applications are conventionally hosted by data centers.

Data centers can occupy varying degrees of space such as a room, one or more floors of a building or an entire building. Inside, equipment is contained within a plurality of racks or rack cabinets arranged in rows to enable access to both the front and back of racks. Each rack can include server, storage, and/or network equipment.

Furthermore, data centers include support equipment such as computer room air conditioning (CRAC) to cool and control humidity in this dense environment. It is crucial to maintain temperature and humidity within a range specified by the equipment manufacturer. If equipment is not adequately cooled, it can malfunction. Similarly, if the humidity is too high, equipment can corrode while if it is to low static electricity can damage the equipment. Conventionally, a number of sensors can be provided throughout the data center to monitor environmental conditions such as temperature and humidity. Additionally, racks can be positioned on a raised floor to allow air to circulate and cool the equipment from below as well as on top.

It is very expensive to operate a data center. In addition, to equipment cost, there is a very large energy cost associated with powering and cooling the equipment. In some situations, energy can be far more expensive than the equipment itself. Moreover, it is estimated that more than thirty percent of data center energy is dedicated to non-computing. Accordingly, data center inefficiencies in design, deployment, and everyday operation can be quite costly.

Organizations are increasingly choosing to utilize collocation centers in addition to or as a substitute for their own enterprise operated data centers. Collocation centers or carrier hotels are a type of data center shared by multiple entities, organizations or the like. This enables organizations to take advantage of the scale benefit associated sharing infrastructure costs (e.g., power, mechanical systems, communication systems . . . ). However, it is still important to collocation operators, customers, and partners to minimize costs associated with inefficiencies.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to improving operation efficiency of data centers. In accordance with one aspect of the disclosed subject matter, data conventionally scattered amongst multiple isolated data center systems and/or sources is integrated into a single system to aid optimization of data center operations. According to another aspect, raw data acquired from the systems and/or sources is analyzed and new data extracted or generated as a function thereof. In accordance with still another aspect, a user interface renders all data in intuitive manners to enable users to quickly grasp intricacies of data center operation and better equip them to operate a data center efficiently. More specifically, the interface facilitates substantially real-time monitoring and control of operations as well as deployment assistance and capacity planning, amongst others.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a data center system in accordance with an aspect of the subject disclosure.

FIG. 2 is a block diagram of a representative data interface component according to an aspect of the subject disclosure.

FIG. 3 is a block diagram of a representative user interface component in accordance with an aspect of the subject disclosure.

FIG. 4 is a block diagram of a representative user interface component including a plurality of action components or embodiments thereof.

FIG. 5 is a block diagram of a representative user interface component including a number of configuration components or embodiments thereof.

FIG. 6 is an exemplary screenshot graphically illustrating a bird's-eye view of a data center.

FIG. 7 is an exemplary screenshot depicting a more detailed, zoomed version of the screenshot in FIG. 6.

FIG. 8a is an exemplary graphical representation of a collection of racks and associated equipment that can be rendered by a user interface in accordance with an aspect of the disclosure.

FIG. 8b illustrates an exemplary heat map applied to the collection of racks depicted in FIG. 8a that can be rendered by a user interface in accordance with an aspect of the disclosure.

FIG. 9 illustrates an exemplary query view and returned results that can be rendered by a user interface according to an aspect of the disclosure.

FIG. 10 is a graphical depiction of a rack cross section renderable by a user interface according to an aspect of the disclosed subject matter.

FIG. 11 is a block diagram of data center system in accordance with an aspect of the disclosed subject matter.

FIG. 12 is a flow chart diagram of a method of data center operations monitoring in accordance with an aspect of the subject disclosure.

FIG. 13 is a flow chart diagram of a data center interaction method according to an aspect of the disclosure.

FIG. 14 is a flow chart diagram of a method of data center equipment deployment according to an aspect of the disclosed subject matter.

FIG. 15 is a schematic block diagram illustrating a suitable operating environment for aspects of the subject disclosure.

FIG. 16 is a schematic block diagram of a sample-computing environment.

### DETAILED DESCRIPTION

Systems and methods are provided hereinafter that facilitate efficient operation of data centers. A system architecture is provided that enables interaction with a plurality of data center systems and/or data sources. Acquired data can be analyzed or otherwise processed to generate and/or extract useful information. This information is provided to a user in an intuitive manner to improve data center operation efficiency. More specifically, a user interface can facilitate substantially real-time monitoring, control, deployment, and capacity planning, among other things.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

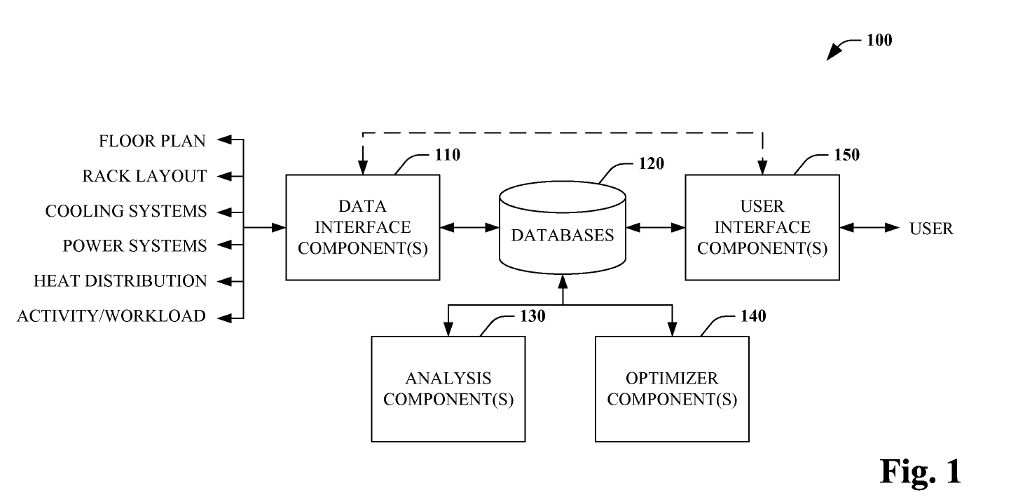

Referring initially to FIG. 1, data center system 100 is illustrated in accordance with an aspect of the claimed subject matter. Data centers include a dense collection of computational equipment in a controlled environment. For example, cooling and other systems are employed to ensure temperature, humidity and other environmental factors are in line with ranges specified by individual equipment manufacturers. Further, power systems can ensure that power is distributed appropriately throughout the data center to support operation thereof. Conventionally, many systems and/or sources that comprise a data center are isolated from each other. More particularly, control, state, and other data is scatter amongst isolated systems each of which includes its own management system. The system 100 provides a mechanism for interfacing with a plurality of different data center systems and/or data sources, generating useful data center information, and providing the data to users in an intuitive manner to facilitate interaction. In other words, dense data center sensing is utilized to achieve operational optimization, monitoring, control, and/or visualization, among other things.

More specifically, the system 100 includes one or more data interface component(s) 110 that can interact with data center systems and/or sources. For example and as illustrated, the data interface component(s) 110 can interact with floor plan data, rack layout data, cooling systems (e.g., CRAC), power systems, heat distribution systems (e.g., sensors), and equipment activity/workload systems. In one instance, the data interface component(s) 110 can acquire information from different sources and provide it to one or more databases 120 for at least temporary storage. By way of example, the data interface component(s) 110 can receive, retrieve or otherwise acquire data center layout data, rack layout data, cooling data (e.g., return temperatures, cooling opening percentage . . . ), power data (e.g., usable power and measured power at each rack . . . ), and/or heat distribution data (e.g., temperature, humidity . . . ) from associated system databases or the like. Other data such as equipment workload can be measured in various ways such as processor utilization percentage and can be collected by an operating system or application counters and stored in a database or warehouse from which one or more data interface components 110 can access. It should also be noted that the data interface component(s) 110 can be designed to acquire all or a portion of data at particular time intervals (e.g., one minute, five minutes, thirty minutes . . . ). For instance, cooling system data and power system data may be obtained in this manner to ensure this oft-changing data is up to date. In another embodiment, such information can be retrieved and stored to one or more databases 120 in real-time or substantially real time given processing and communication delays, among other things.

One or more databases 120 can house information acquired by the data interface component(s) 110 for access by user interface component(s) 150. In accordance with one non-limiting embodiment, a staging database can be employed. By way of example, the database(s) 120 can include the physical layout of equipment in a data center to the granularity of racks. In a typical data center, there are server racks, telecommunication racks, power distribution units, and computer-room air conditioning units. This physical layout can be maintained as drawings in a top down view, but is not limited thereto. Additionally, the database(s) 120 can include a rack layout table including rack item id, name, data center, collocation, row, cabinet, beginning slot number and number of slots the item occupies. Further, data can be stored in the database(s) 120 as timestamped values to facilitate a relevance determination.

The system also includes analysis component(s) 130 and optimizer component(s) 140 communicatively coupled to the database(s) 120. The analysis component(s) 130 analyzes stored data and generates or extracts useful information. Based on data acquired from one or more stores, the analysis component 130 can determine or infer other information that may be useful and store it to the database(s) 120. For example, a moving average of the ninety percent median can be employed as an indicator to capture historical usage or trend and remove data spikes. The optimizer component 140 can optimize the storage of data, information, and the like to facilitate expeditious retrieval. For example, data can be indexed in a table or related data can be persisted in close proximity.

The user interface component(s) 150 renders data center data in an intuitive fashion to aid expeditious comprehension and interaction. For example, the user interface component(s) 150 can present realistic spatial and temporal relations amongst data. In one instance, the user interface component(s) 150 can correspond to a web-based visualization interface. In any event, the user interface component(s) 150 can be employed to monitor data housed in the database(s) 120 in real time or substantially real time, for example. Further yet, the user interface(s) 150 can be employed to receive information to query or otherwise alter data, settings, configurations or the like. Queries can be processed by a database 120 or more specifically an associated database management system query processor (not shown). Alterations can be made indirectly via changes to the database 120 that can be read and propagated by the data interface component(s) 110 or more directly through the data interface component 110.

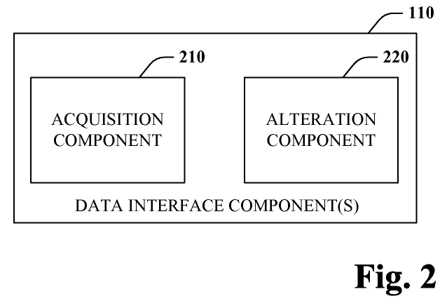

FIG. 2 illustrates a representative data interface component 110 in accordance with an aspect of the claimed subject matter. As previously described, the data interface component 110 can facilitate interaction with a plurality of data center related data. A single data interface component 110 can be employed to interact with many different sources or alternatively more than one component 110 utilized, each of which is designed to work with a particular source or group of sources. Implementations can vary. The data interface component 110 can include an acquisition component 210 and/or an alteration component 220.

The acquisition component 210 is a mechanism for receiving, retrieving, or otherwise acquiring data. This can allow the data interface component 110 to pull data from sources to a database, for instance. By way of example, the acquisition component 210 can enable rack layout information to be pulled from a database that maintains, among other things, server locations. Further, the acquisition component 210 can be configured to acquire environment, power, and/or workload data, for instance, at predefined time intervals.

The alteration component 220 is a mechanism for changing, altering, or otherwise modifying data, settings, and/or configurations, among other things. In this manner, control can be provided over things that are monitored. For example, server or air conditioning settings can be adjusted via the data interface component 110 and more specifically alteration component 220.

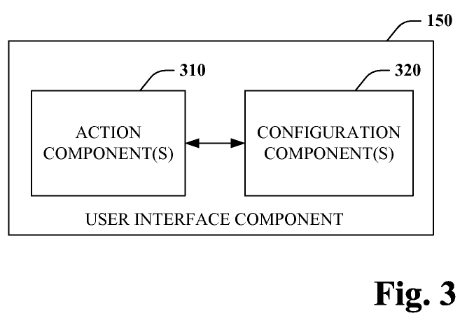

FIG. 3 depicts a representative user interface component 150 in accordance with an aspect of the claimed subject matter. As previously described, the user interface component 150 is operable to render as well as acquire information. Moreover, it provides a means to easily comprehend and interact with data center information, for instance utilizing spatial and/or temporal presentation mechanisms rather than solely a bunch of data tables or plots. As shown, the user interface component 150 can include or otherwise interact with one or more action components 310 and configuration components 320. The action component(s) 310 provide specific functionality relating to rendering, receiving or otherwise interacting with data center data. In other words, the user interface component 150 can be customized for particular situations or scenarios. The configuration component(s) 320 can interact with the action component(s) 310 and provide one or more interface configurations. As will be appreciated with respect to figures and description below, the configuration component(s) 320 can alter the way in which information is provided and utilized to allow individuals to easy grasp and interact with data center information.

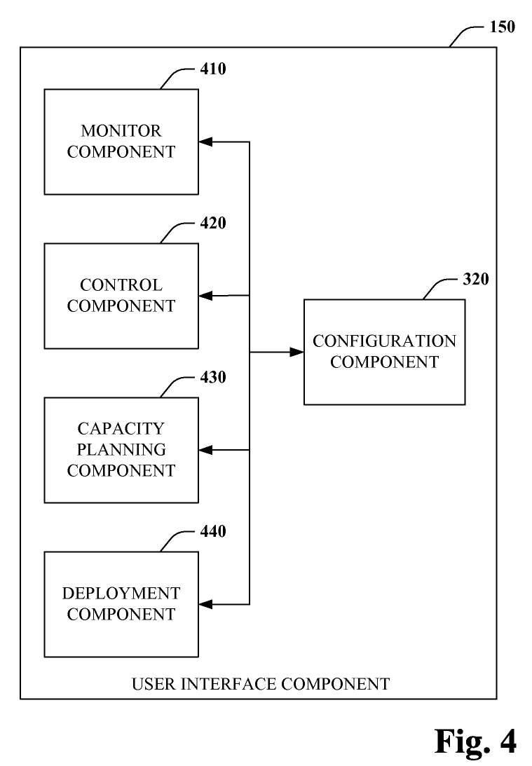

Referring to FIG. 4, a representative user interface component 150 is illustrated including a plurality of action components 310 or embodiments thereof. As shown, the interface component 150 includes a configuration component 320 as previously and subsequently described as well as four action components, namely monitor component 410, control component 420, capacity planning component 430 and deployment component 440. While particular systems can include monitoring functionality, the monitor component 410 provides information in the context of an entire data center or portion thereof. Data is integrated across many systems and/or sources and presented to a user to enable them to monitor data center operations easily. Furthermore, in one embodiment monitoring can be effected in real or substantially real-time. Further yet, a query interface can be provided by the monitor component 410 to specify particular data of interest.

Similarly, the control component 420 provides a mechanism to easily alter, set or otherwise control data center operations. A user can click, drag, gesture, or otherwise enter information via a graphical display, for instance, provided by the monitor component 410. For example, where it is noticed that a particular area is heating up, the control component 420 can be utilized to adjust air condition units, turn servers off, or shift load, among other things, to remedy the issue.

The capacity-planning component 430 can aid understanding of data center limitations or capacity. It can assist users in exploring and determining data center capabilities to facilitate planning with respect to center expansion, for instance. Users can employ the capacity planning component 430 to determine limiting factors and there relationship(s). Various models and computer algorithms can be utilized with respect to this analysis. By way of example, a determination can be made as to whether the current data center is constrained by size, power and/or its ability to dissipate heat. If size is the main constraint, the data center can be expanded. However, additional factors can be analyzed by the capacity-planning component 430 such as whether additional cooling or power systems are needed to support a physical expansion.

The deployment component 440 provides functionality similar to the capacity-planning component 430 and may be utilized in combination. More specifically, the deployment component 440 can aid determinations as to how resources should be distributed and utilized in a data center. Again, various models and computer-executed algorithms can be employed. For instance, one or more statistical models can be employed to predict the effect different actions within the data center. Accordingly, the deployment component 440 can support a number of “what if” scenarios to aid efficient deployment of data center resources. For example, what if a server is moved from location one to location two, and how will that effect heat distribution? The deployment component 440 can also determine or infer optimal utilization from models or the like and provide suggestions to users.

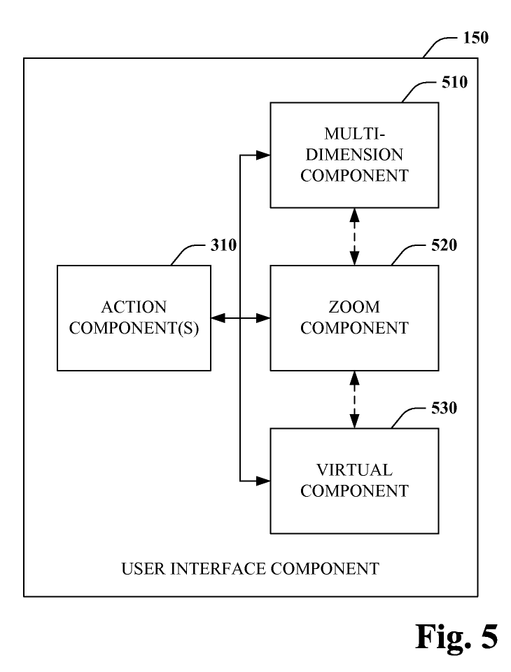

Turning attention to FIG. 5 a representative user interface component 150 is depicted including a number of configuration components 320 or embodiments thereof. As previously described, the user interface component 150 can include one or more action components 310 to provide specialized interaction capabilities. Additionally, the interface component 150 includes a plurality of configuration components or embodiments thereof, specifically multi-dimension component 510, zoom component 520 and virtual component 530.

The multi-dimension component 510 affords data in multiple dimensions. Standard two-dimensional graphics, text, and sound and the like can be generated in one instance. Additionally or alternatively, the component 510 can render a three dimensional presentation. For example, a three-dimensional data center layout can be rendered on a standard two-dimensional display, wherein a user can change a viewpoint to view the layout from different angles. As an alternative, advanced three-dimensional technology can be employed.

The zoom component 510 provides unique functionality related to zooming in and out with respect to data provided by the user interface. User can pan to different points and zoom in and out at various levels. For instance, a user can first view a data center layout and then zoom in on a particular rack therein. Not only can the zoom component 512 enable this functionality, but also, utilizing various algorithms, it can ensure data is summarized at various levels of granularity across a viewing area. At the bottom level is data collected from different data-center systems and data sources (e.g., raw temperature, power, and load observations). As a user zooms out, data is aggregated and provided at a particular level of granularity. For instance, raw temperature data from multiple sensors on a rack can be aggregated and rendered as an average temperature for the rack. A user can then see temperature associated with each rack. Continued zooming out can then result in aggregation of data further into particular groups or zones.

Virtual component 530 can utilize functionality provided by both multi-dimension component 510 and zoom component 520, among other things, to create a virtual world for navigation by users. Various technologies in the art can be employed and applied here to create a virtual data center. Users can then virtually walk through the data center to monitor operations and make adjustments in a manner similar to if they were physically present. For example, a user could approach an air conditioning unit and adjust its fan speed with a virtual control that resembles the physical control. Moreover, the virtual world is not limited by the physical world. Hence, the virtual world can be generated to provide a better interactive experience. For example, a user can select a visually identified load on a server and drag and drop all or a portion of it on to another server.

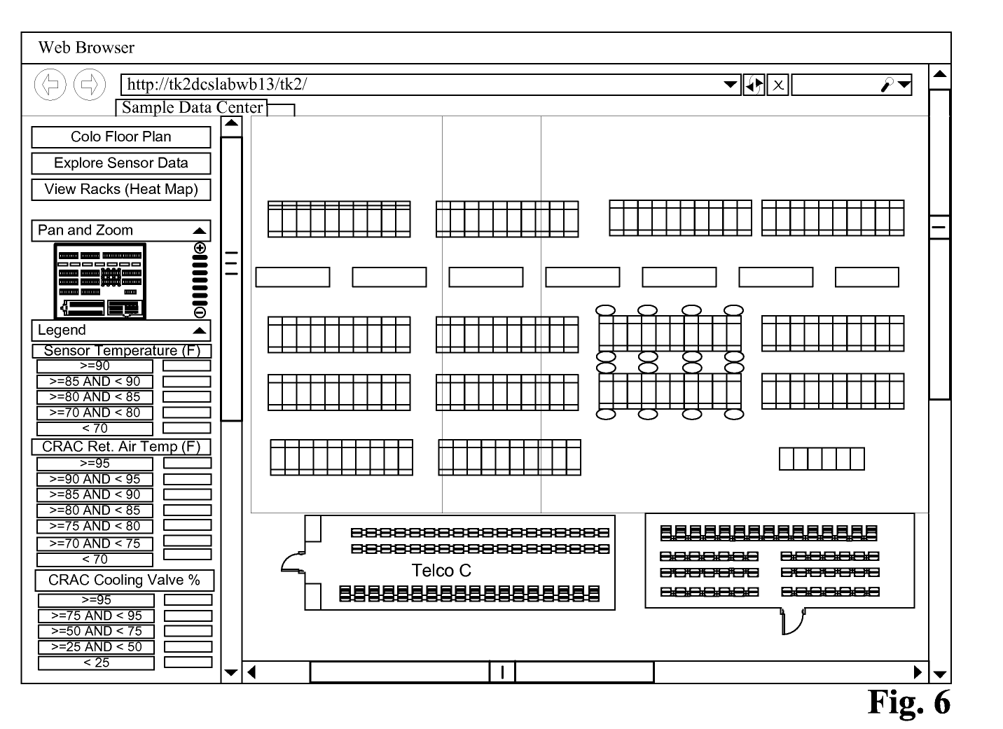

Turning to FIGS. 6-10 a plurality of exemplary screenshots and/or graphics associated with the user interface of the subject disclosure. These screenshots are afforded to facilitate clarity and understanding with respect to aspects of the claimed subject matter. The claimed subject matter is not intended to be limited by these screenshots since data can be rendered in many addition ways not provided for purposes of brevity.

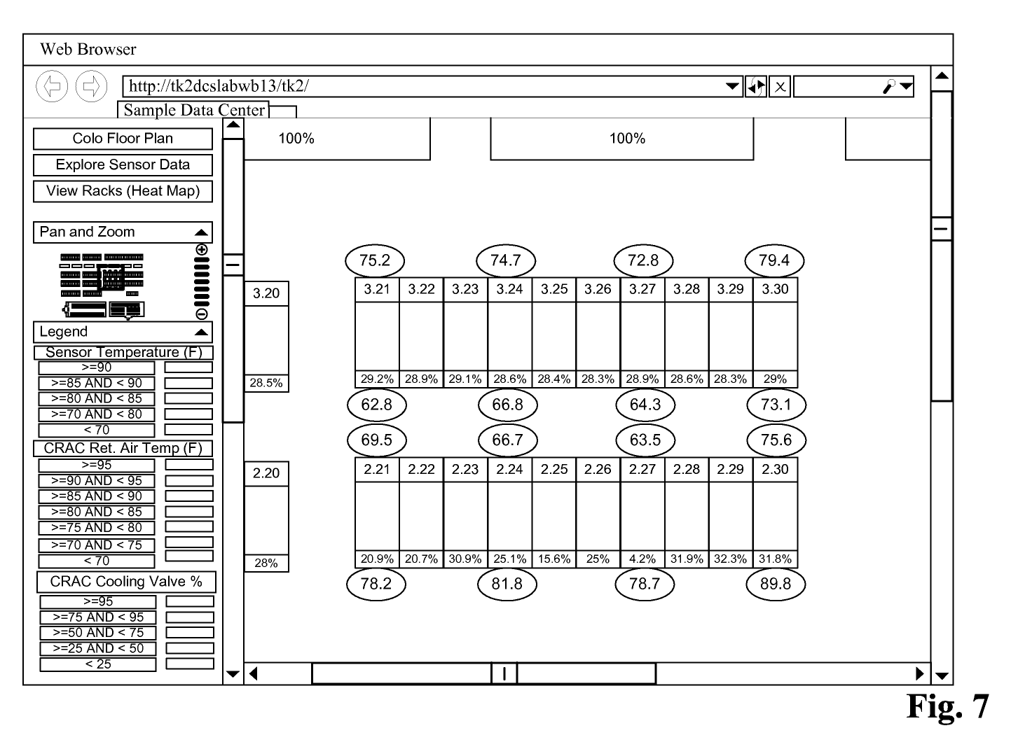

Referring first to FIGS. 6 and 7, a top or bird's-eye view of a data center is graphically captured. FIG. 6 depicts a high-level view, whereas FIG. 7 illustrates a more detailed zoom version. Color, shades of color, hatching or the like can be utilized to easily grasp the state of data center operations captured by a dense sensor network. For instance, each rack can be associated with a gray scale wherein the darker the color the fuller the rack—white identifying an empty rack and black denoting a full rack. Further, rack boundaries can be colored to indicate ownership of the equipment therein. A pan and zoom window is also provided to identify a portion of the data center and zoom in or zoom out. Zooming in can result in the display changing as shown in FIG. 7.

Here, information is a little more specific including identifiable numeric data. In particular, below each rectangle representative of a rack a smaller rectangle is provided designating a power consumption percentage computed as the measured power consumption divided by the usable power. The percentage can also be converted into a representative color code. For instance, green can correspond to less than thirty percent, yellow between thirty and fifty percent, and so on. Temperature sensors are illustrated as ovals close to their location including a numeric value and/or color indicative of a measured temperature. Computer room air conditioners are similarly illustrated capturing opening percentage. For example, a percentage of less than ninety-five indicates there is not much extra cooling capacity on that unit. Further, the return air temperature (RAT) can be indicated by background color. The lighter the color or shade of color being indicative of a lower temperature.

Although not shown here, it should also be appreciated that rolling over equipment can result in a tool tip being spawned with more detailed information. By way of example and not limitation, hovering a mouse cursor at a rack can result in key information being shown as a tool tip including rack name, primary property owner, number of empty slots, measured power consumption, and usable power.

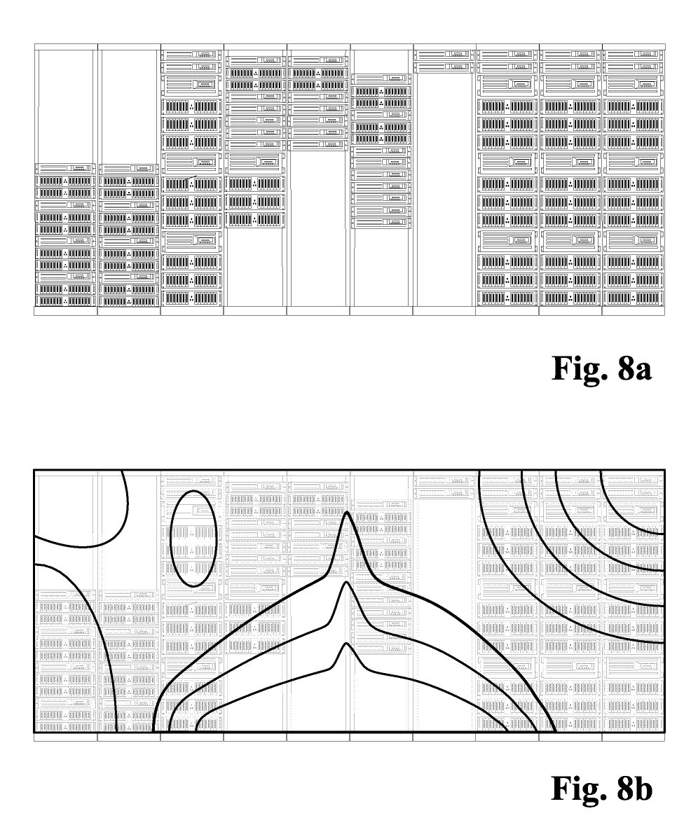

FIG. 8a illustrates a graphical representation of a collection of racks that can be rendered by a user interface. The rack layout depicted can be helpful in identifying rack equipment as well as available rack space. Furthermore, a heat map can be generated and applied over the collection of racks as shown in FIG. 8b. The heat map can be generated from data from sensors on the front and/or back of the rack. Accordingly, a heat map can be generated for both the front and back of the collection of racks, wherein the rack layout forms the background to enable identification of hot spots or other problem areas, for instance.

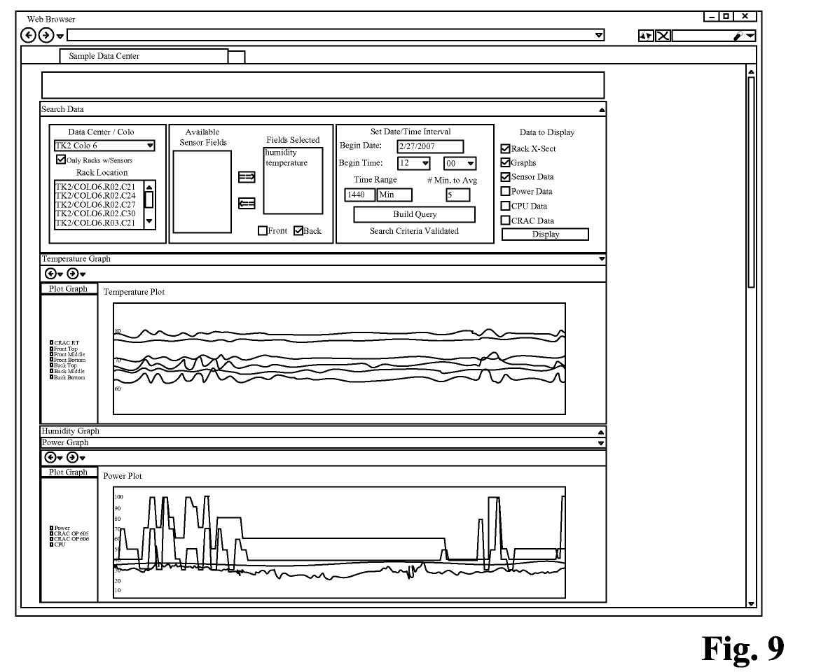

FIG. 9 a data query view associated with a user interface. A user interface can provide this view to allow users to get raw or more specific data about the data center. Graphical mechanisms are provided to identify racks, sensors, sensor fields, as well as date and time intervals. Returned data can be provided in a data plot view or a data grid view as shown. Additionally or alternatively, results can be saved or exported to files or spreadsheets for further processing by other applications.

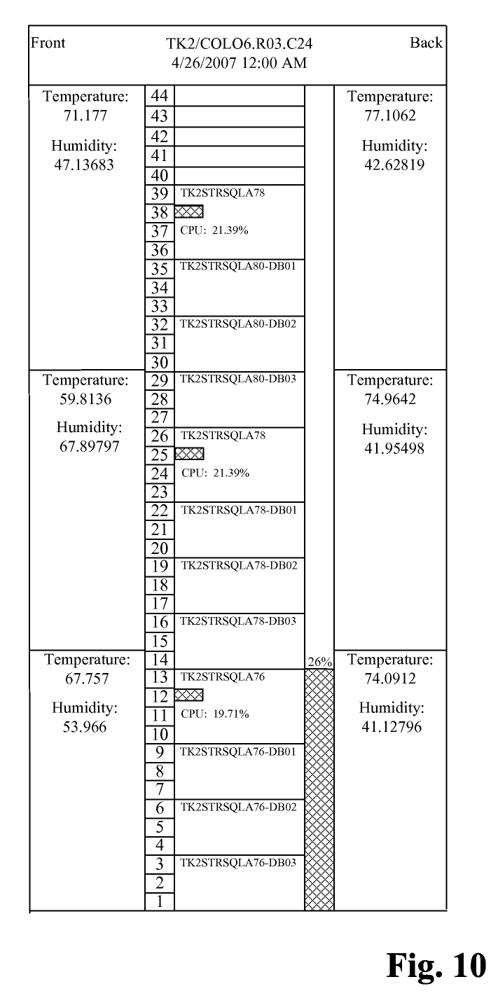

Resultant query data can also be presented with respect to a rack cross section as shown in FIG. 10. Here, data is provided in a more easily comprehensible fashion. The cross section view illustrates rack slots, server names, power consumption as well as temperature and humidity at different locations. Further yet, server workload is indicated by a horizontal bar below a servers name as well as with a numerical value.

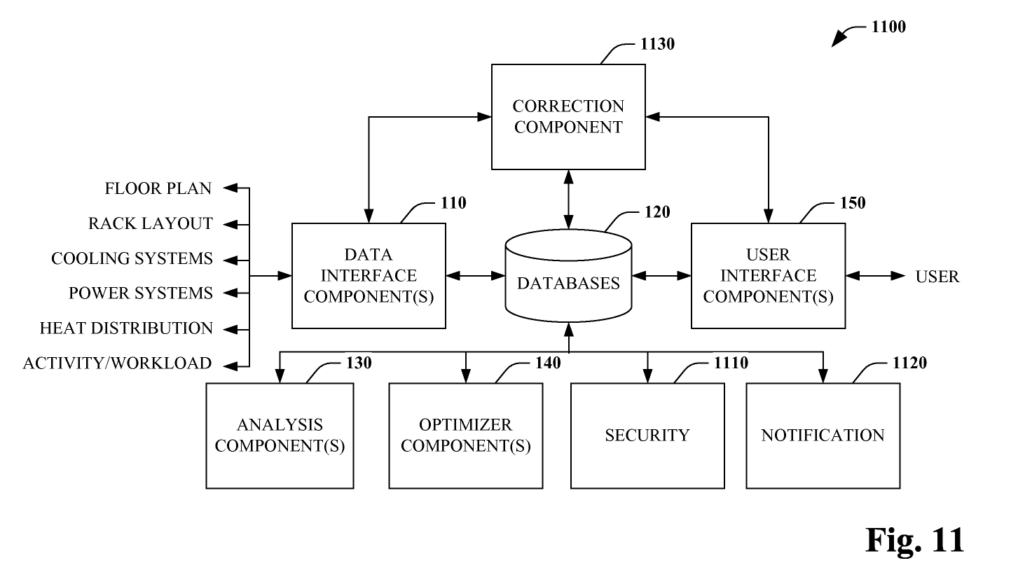

Referring to FIG. 11, a data center system 1100 is illustrated in accordance with an aspect of the claimed subject matter. Similar to system 100 of FIG. 1, system 1100 includes the data interface component(s) 110, database(s) 120, analysis component(s) 130, optimizer component(s) 140, and user interface components 150, as previously described. Briefly, the data interface component 110 facilitates interaction with a number of data center systems and/or sources and can persist such data to one or more databases 120. The analysis component(s) 130 and optimization component(s) 140 can alter, move, and/or generate information as a function of the raw data housed in the database, among other things. The user interface component(s) 150 facilitates intuitive interaction with the data and/or information. It is to be appreciated that various additional functionality can be employed in conjunction with such a system. As shown, system 1100 also includes a security component 1110, notification component 1120, and correction component 1130.

The security component 1110 controls assess to data center systems and data sources, among other things. Permissions can be associated with individuals or groups of individuals. The security component 1110 can provide functionality associated with identifying such entities via user name and pass code, biometrics or other technology known in the art. Subsequent to positive identification, the security component 1110 can operate to control distribution of information from the database(s) 120 as well as interaction with the data interface component 110. In this manner, rendered information can via user interface component 150 can be restricted to that available to a particular security clearance. Similarly, such security clearance can govern if and how changes are made in the operation of the data center.

The notification component 1120 can notify or alert appropriate personal upon the occurrence of an event. For example, an operating condition such as a temperature can be set and monitored by the notification component 1120. The condition can also specify an individual or entity to notify and a manner of notification. Upon satisfaction of the condition, the notification component can generate a notification and transmit the notification to a designated person via email and/or text message, for example. Additionally or alternatively, the notification or alert can appear on a rendered display, for example upon login of the designated person.

The correction component 1130 is operable to automatically make corrections to data center operations. Users via the user interface component(s) 150 can set conditions that designate automated responses to the occurrence of such conditions. The correction component 1130 can monitor data center options via the database(s) 120 and/or data interface component(s) 110 and initiate a response through the data interface component(s) 110 upon satisfaction of a condition. For example, upon detection that an air conditioning unit failed or otherwise shut down, the correction component 1130 can initiate a response that shifts load from proximate servers away from the unit. Further yet, the correction component 1130 can automatically learn conditions and responses from user action or other suitable training data such that upon occurrence the correction component 1130 can respond automatically and intelligently.

The aforementioned systems, architectures, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems above and methods below can include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, one or more action components 310 can utilize such mechanisms to intelligently assist users. Additionally, the correction component 1130 can employ these mechanisms to learn conditions and responses.

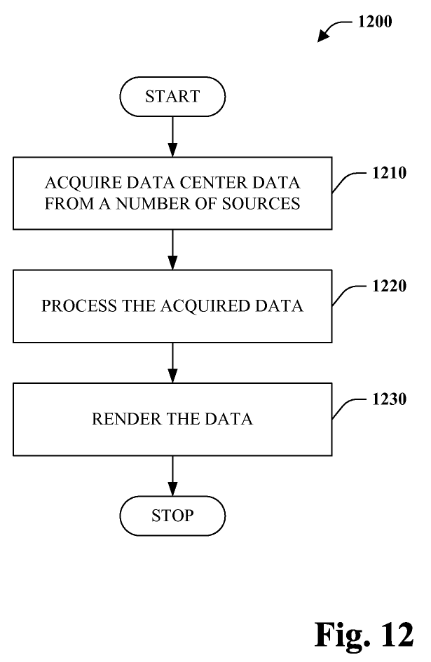

In view of the exemplary systems described supra, methodologies that may be implemented in accordance with the disclosed subject matter will be better appreciated with reference to the flow charts of FIGS. 12-14. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 12, a data center operations monitoring method 1200 is depicted in accordance with an aspect of the claimed subject matter. At reference numeral 1210, data center data is acquired from multiple systems and/or sources. For purposes of example and not limitation, a plurality of data pulling agents can be utilized to acquire data at intervals from such systems and/or sources and provide it to a staging area such as a database. The acquired data is processed at 1220. Processing can comprise synchronizing data based on time stamps, extracting or generating information from the data, and/or optimizing store of the data for expeditious access, among other things. For example, a set of data acquired at the same time can be aggregated or otherwise computed to generate new information that is persisted to a database.

At reference numeral 1230 data and/or generated information is rendered for instance to a display to facilitate monitoring by users. Rendering of such data/information can be accomplished in an intuitive manner such that information is easily comprehendible by users. In one embodiment, this can be accomplished by via spatial and/or temporal graphical representations as opposed to merely providing a list or chart of data (although this is also possible). For example, data/information can adorn a graphical depiction of a data center layout and/or be utilized to create graphics themselves (e.g., heat map). Further, users can pan and zoom to see information computed at various levels of granularity. In one particular instance, a virtual data center can be generated that allows individuals to navigate the data center virtually rather than physically. It is to be appreciated that by employing dense sensing across a data center support is provided for more meaningful decision making than is otherwise possible. Decision-making can further be improved as a function of data availability (e.g., real-time, substantially real-time . . . ).

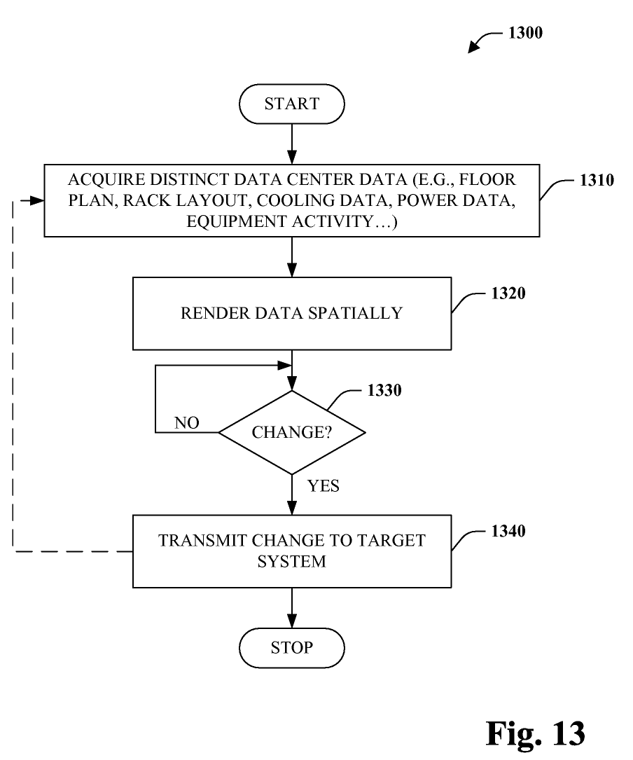

FIG. 13 depicts a method 1300 of data center interaction in accordance with an aspect of the claimed subject matter. At reference numeral 1310, distinct data is received, retrieved, or otherwise acquired from multiple systems and/or sources associated with a data center. For instance, acquired data can pertain or correspond to a data center floor plan, rack layout, cooling, power and workload or activity. At numeral 1320, the data and/or related information can be rendered spatially or in some other intuitive manner. A determination is then made at numeral 1330 as to whether a change as been input. For example, a user can input a changed opening percentage for a computer room air conditioner with respect to the rendered data by overriding presented number or otherwise interacting with a graphical control, among other things. If a change as been input, the method continues at numeral 1340 where the input change is transmitted to the associated system or data store to effect the change. Alternatively, the method 1300 can loop until a change has been detected. The method 1300 can then terminate or alternatively continue at numeral 1310 where data is acquired reflecting changes made and rendered at 1320. Any changes will then be updated in the rendered presentation.

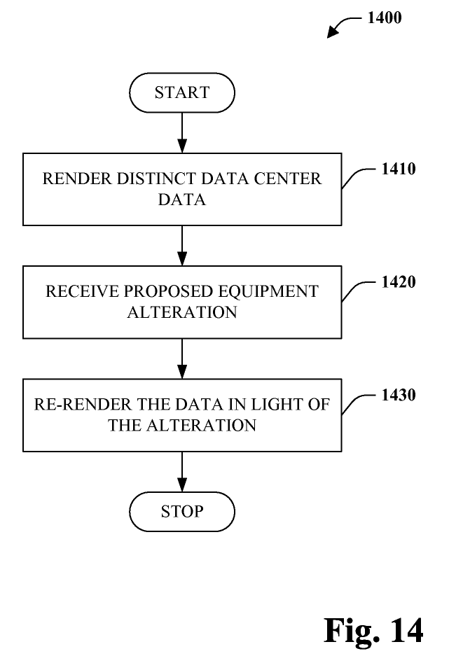

FIG. 14 is a flow chart diagram of a method 1400 of equipment deployment in a data center according to an aspect of the claimed subject matter. At reference numeral 1410, distinct data center data is rendered in an intuitive manner to a display, for instance. At numeral 1420, proposed alteration such as addition, removal, or movement of equipment is received. Data is re-rendered taking into account the proposed alteration at reference numeral 1430. In this manner, users can explorer various equipment deployment operations and their effect on the data center without having to physically make such changes. The method 1400 can thus handle “what if” scenarios in an attempt to improve operational efficiency and/or predict failure. One or more predictive models can be utilized to predict or infer alteration consequences.

As used herein, the terms “component,” “system” and the like are intended to refer to a computer-related entity, either hardware, a combination of hardware and software, software, or software in execution. For example, a component can be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” or various forms thereof are used herein to mean serving as an example, instance or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated that a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject innovation.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

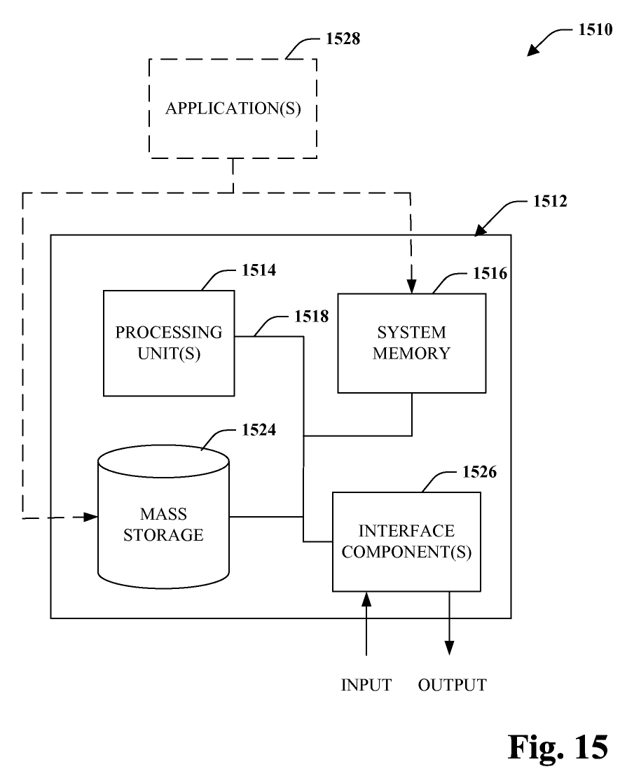

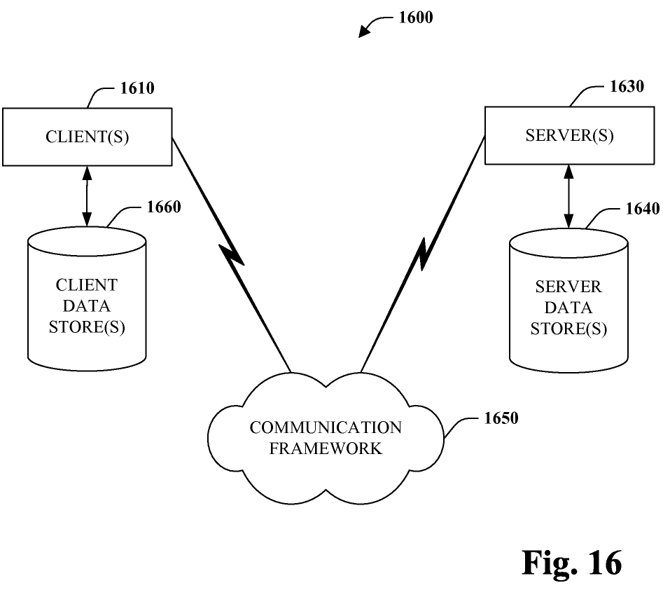

In order to provide a context for the various aspects of the disclosed subject matter, FIGS. 15 and 16 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 15, an exemplary environment 1510 for implementing various aspects disclosed herein includes a computer 1512 (e.g., desktop, laptop, server, hand held, programmable consumer or industrial electronics . . . ). The computer 1512 includes a processing unit 1514, a system memory 1516, and a system bus 1518. The system bus 1518 couples system components including, but not limited to, the system memory 1516 to the processing unit 1514. The processing unit 1514 can be any of various available microprocessors. It is to be appreciated that dual microprocessors, multi-core and other multiprocessor architectures can be employed as the processing unit 1514.

The system memory 1516 includes volatile and nonvolatile memory. The basic input/output system (BIOS), containing the basic routines to transfer information between elements within the computer 1512, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 1512 also includes removable/non-removable, volatile/non-volatile computer storage media. FIG. 15 illustrates, for example, mass storage 1524. Mass storage 1524 includes, but is not limited to, devices like a magnetic or optical disk drive, floppy disk drive, flash memory, or memory stick. In addition, mass storage 1524 can include storage media separately or in combination with other storage media.

FIG. 15 provides software application(s) 1528 that act as an intermediary between users and/or other computers and the basic computer resources described in suitable operating environment 1510. Such software application(s) 1528 include one or both of system and application software. System software can include an operating system, which can be stored on mass storage 1524, that acts to control and allocate resources of the computer system 1512. Application software takes advantage of the management of resources by system software through program modules and data stored on either or both of system memory 1516 and mass storage 1524.

The computer 1512 also includes one or more interface components 1526 that are communicatively coupled to the bus 1518 and facilitate interaction with the computer 1512. By way of example, the interface component 1526 can be a port (e.g., serial, parallel, PCMCIA, USB, FireWire . . . ) or an interface card (e.g., sound, video, network . . . ) or the like. The interface component 1526 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 1512 to output device(s) via interface component 1526. Output devices can include displays (e.g., CRT, LCD, plasma . . . ), speakers, printers and other computers, among other things.

FIG. 16 is a schematic block diagram of a sample-computing environment 1600 with which the subject innovation can interact. The system 1600 includes one or more client(s) 1610. The client(s) 1610 can be hardware and/or software (e.g., threads, processes, computing devices). The system 1600 also includes one or more server(s) 1630. Thus, system 1600 can correspond to a two-tier client server model or a multi-tier model (e.g., client, middle tier server, data server), amongst other models. The server(s) 1630 can also be hardware and/or software (e.g., threads, processes, computing devices). The servers 1630 can house threads to perform transformations by employing the aspects of the subject innovation, for example. One possible communication between a client 1610 and a server 1630 may be in the form of a data packet transmitted between two or more computer processes.

The system 1600 includes a communication framework 1650 that can be employed to facilitate communications between the client(s) 1610 and the server(s) 1630. The client(s) 1610 are operatively connected to one or more client data store(s) 1660 that can be employed to store information local to the client(s) 1610. Similarly, the server(s) 1630 are operatively connected to one or more server data store(s) 1640 that can be employed to store information local to the servers 1630.

Client/server interactions can be utilized with respect with respect to various aspects of the claimed subject matter. Most notably, disclosed mechanisms and/or methods can be applied with respect to one or more servers 1630 and server data stores 1640. Additionally, it should be appreciated that the user interface can correspond to or be embodied as a network or web interface. In this manner, data/information persisted to server data store 1640 can be transmitted or otherwise made accessible to a network browser application executing on a client 1610 over the communication framework 1650.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

What is claimed is:

1. A data center system, comprising:
one or more data interface components that interact with different types of data center data afforded by multiple systems and/or sources; and
a user interface component that renders the data in intuitive ways to facilitate operation of a data center.

2. The system of claim 1, further comprising a staging database that houses the data for acquisition by the user interface component.

3. The system of claim 2, the data is timestamped to facilitate synchronization in time intervals.

4. The system of claim 2, further comprising an analysis component that analyzes the data and inserts new data into the database as function thereof.

5. The system of claim 2, further comprising an optimization component that organizes the data to optimize retrieval time.

6. The system of claim 1, comprising a monitor component to enable substantially real-time monitoring of the data.

7. The system of claim 1, comprising a control component to enable control of the multiple systems and/or sources.

8. The system of claim 1, comprising a component that facilitates data center capacity planning.

9. The system of claim 1, further comprising a deployment component to assist deployment of data center equipment.

10. The system of claim 1, the multiple systems and/or sources include two or more of a cooling system, power system, heat distribution system, workload system, and data center layout data.

11. The system of claim 1, the user interface component includes a component that enables zooming in and out to facilitate observation and/or interaction with data at various levels of granularity.

12. The system of claim 1, the user interface generates a virtual data center that facilitates interaction with the data center.

13. A data center interaction method, comprising:
acquiring data from multiple sources providing dense sensing across a data center; and
rendering the data spatially in substantially real-time.

14. The method of claim 13, further comprising rendering data at increasing levels of granularity in response to a request.

15. The method of claim 13, further comprising rendering more granular data upon rollover or hovering.

16. The method of claim 13, further comprising:
receiving a request to modify operation of a system; and
transmitting the request to the system to the system to effect a change.

17. The method of claim 13, further comprising:
receiving a request for raw data; and
rendering the data in plot view, a grid view and/or a rack cross section view.

18. The method of claim 13, further comprising notifying an individual upon satisfaction of one or more preset conditions.

19. The method of claim 13, acquiring data center floor plan, rack layout, cooling, power, heat distribution, and equipment activity data.

20. A data center system, comprising:
means for interacting with data center data from multiple distinct sources; and
means for presenting the data spatially in substantially real-time to facilitate at least one of monitoring operations, controlling operations, deployment, and capacity planning.
